(19) United States
(12) Patent Application Publication
(10) Pub. No.: US 2007/0276738 A1
(43) Pub. Date: Nov. 29, 2007

(54) Method of prepaid gasoline and other motor vehicle propellant products fixed price retail purchasing

(76) Inventor: Joseph V. Rajunas III, Edgewood, NM (US)

Correspondence Address: AMERICAN FINANCIAL INSTITUTIONS CONSULTING, INC., 3255 HWY 317, SUITE P-136, SUWANEE, GA, 30024, US

(21) Appl. No.: 11/232,232

(22) Filed: Sep. 20, 2005

(51) Int. Cl. G06Q 30/00

(52) U.S. Cl. 705/26

(57) ABSTRACT

This application describes a system and method whereby, a consumer can prepay for Petroleum Products at a Fixed Price via an encoded plastic magnetic-type information card or printed receipt, in advance (“Prepaid”), gasoline and other motor vehicle propellant products (“Petroleum Products”) at a fixed price for later consumption from one or more merchants. The fixed price is achieved by the Merchant purchasing or allotting a corresponding amount of Petroleum Product commodity to exactly offset the amount (in gallons) of Petroleum Product purchased by the consumer at the retail merchant location (“Fixed Price”) and the system entails a centralized computer system. The consumer has thus, pre-paid and locked in a Fixed Price purchase of the Petroleum Product and the Merchant has hedged a corresponding amount of Petroleum Product so that a fluctuation in the market price of the Petroleum Product does not increase the price risk to the Merchant.

This invention relates to a system and method whereby, a consumer can prepay for a specific quantity, in gallons, of gasoline or other motor vehicle propellant products at a Fixed Price via an encoded plastic magnetic-type information card or printed receipt, in advance (“Prepaid”), at a fixed price for later consumption from one or more retail merchants.

1. This application describes a system and method for securely purchasing at retail, in advance (hereinafter “Prepaid”), gasoline and other motor vehicle propellant products (hereinafter “Petroleum Products”) at a fixed price for later consumption from one or more merchants.

2. The fixed price is achieved by purchasing a corresponding amount of Petroleum Product commodity to exactly offset the amount of Petroleum Product purchased by the consumer at the retail merchant location (hereinafter the “Fixed Price”).

3. The invention comprises an encoded plastic magnetic-type information card having an account or access number and other identification and access data encoded, embossed, or printed on the card and a centralized computer system that receives the encoded, embossed, or printed data and allows the cardholder to prepay for Petroleum Products at a Fixed Price for multiple refills or recharges of motor vehicles at a later date and time.

4. In one embodiment of the invention, a digital electronic chip is encased within the plastic card (a smart card chip) that securely contains the encrypted account or access number and other identification and access data used by the system for the prepayment of Petroleum Products at a Fixed Price, from one or more merchants.

5. In another embodiment of the system and method, the account or access number and other identification and access data used by the system for prepayment of Petroleum Products at a Fixed Price, from one or more merchants is embossed or printed on a secured “scratch off panel” so that the consumer purchases media at a retail merchant and obtains the account number or access data only after scratching off the panel to disclose said data; whereupon the consumer uses the system for prepayment of Petroleum Products at a Fixed Price, from one or more merchants.

6. In another embodiment of the system and method, the account or access number and other identification and access data (“Access Number”) used by the system for prepayment of Petroleum Products at a Fixed Price from one or more merchants is printed on the consumers receipt so that the consumer purchases a specific quantity of Petroleum Products at a retail merchant location and obtains the Access Number; whereupon the consumer uses the system for secure prepayment of Petroleum Products at a Fixed Price.

7. Also part of the method, consumers are given access to their respective remaining Petroleum Products prepayment values by internet access to the centralized computer system.

8. In a further embodiment of the invention, consumers can, using point-of-sale terminal card-reading devices at multiple merchants, purchase additional units allowing the prepayment of additional Petroleum Products corresponding to the amount loaded on the plastic card at the merchants' point-of sale terminals.
